(19) United States
(12) Patent Application Publication
(10) Pub. No.: US 2006/0143088 A1
(43) Pub. Date: Jun. 29, 2006

(54) Retail distribution of OTC automatic external defibrillators

(76) Inventors: Wendy Katzman, Seattle, WA (US); Jonathan L. Weil, Seattle, WA (US)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(21) Appl. No.: 11/190,347

(22) Filed: Jul. 26, 2005

Related U.S. Application Data
(60) Provisional application No. 60/639,476, filed on Dec. 27, 2004.

(51) Int. Cl. G06Q 20/00

(52) U.S. Cl. 705/16

(57) ABSTRACT

A method of distributing over-the-counter automatic external defibrillators is provided which strikes a balance between the desire to facilitate widespread OTC AED distribution without recording purchaser contact information at the point of sale and the desire to be able to contact OTC AED purchasers in the event of the need to provide them with important information. The OTC AEDs are sold with no contact information reporting requirement at the point of sale. However, the OTC AED is sold with instructions for sending purchaser contact information to the manufacturer as by a mail-in postcard or Website registration. In the event of a situation requiring that purchasers be contacted, the retailer provides information it may have on hand which facilitates the contact of OTC AED purchasers.

This application claims the benefit of Provisional U.S. patent application Ser. No. 60/639,476, filed Dec. 27, 2004.

This invention relates to automatic external defibrillators (AEDs) and, in particular, to AEDs which can be sold to individuals over the counter (OTC) without a prescription.

Automatic external defibrillators have been in use for a number of years to treat individuals stricken with sudden cardiac arrest, one of the largest causes of death in the United States. Sudden cardiac arrest (SCA) most often occurs without warning, striking many people with no previously recognized symptoms of heart disease. It is estimated that more than 1000 people per day are victims of sudden cardiac arrest in the United States alone. SCA results when the electrical component of the heart no longer functions properly, causing an abnormal rhythm. One such abnormal rhythm, ventricular fibrillation (VF), is caused by disordered electrical activity in the heart. As a result, the heart fails to adequately pump blood through the body. VF may be treated by applying an electric shock to a patient's heart through the use of a defibrillator. The shock clears the heart of abnormal electrical activity (in a process called “defibrillation”) by producing a momentary asystole and providing an opportunity for the heart's natural pacemaker areas to restore normal rhythmic function. When delivered external to the patient, these electrical pulses are high energy pulses, typically in the range of 30 to 360 Joules of energy.

Defibrillators have undergone an evolution over the past decade. Originally defibrillators were manual devices requiring both medical and technical expertise to operate. A physician would carefully set the controls of the defibrillator to apply a shock which diagnosis of the patient or experience with other patients in similar conditions indicated to be most likely to be effective. Following many years of experience with manual defibrillators and motivated by advances in microprocessing and signal analysis, defibrillators have become more automated to the point where two electrode pads attached to a patient's chest can detect and diagnose VF and deliver an appropriate shock through the chest wall with little or no user intervention beyond the application of the electrodes to the patient. However such automated defibrillators continued to be prescription devices used by medical professionals or under the auspices of a controlled emergency response program as described in U.S. Pat. No. 6,694,299. But recently the US Food and Drug Administration has approved these automated defibrillators for sale to laypersons without prescription, as over-the-counter (OTC) medical devices. AEDs may now be sold through retail channels (stores, websites, catalogs) and purchased by anyone for use at home in the event of a sudden cardiac arrest emergency.

Prescription AEDs are prescribed to patients by physicians or used by trained medical professionals of emergency response organizations. Prescription AEDs are also found in institutions such as hospitals, airports, office buildings, and factories in a program directed by a nurse, physician or safety officer with trained emergency responders. When AEDs are sold over-the-counter, no medical professional need authorize its sale or oversee its use. When an AED needs servicing or maintenance such as new electrode pads, a new battery, or new electronic or software components to improve its performance or remedy a deficiency, there is no prescribing physician or other medical professional to contact. Moreover, when AEDs are distributed by prescription the manufacturer knows the identity and location of the owner at the time of sale, and a record is kept of this information in case the owner needs to be contacted by the manufacturer or the Food and Drug Administration (FDA). However, OTC AEDs are sold directly to laypersons by mass distribution outlets that are generally ill equipped to record names and contact information of OTC AED purchaser/owners and are usually reluctant to set up a system to do so and report this information to the AED manufacturer, citing cost, incompatible distribution requirements, and consumer privacy concerns. One solution to this dilemma would be to restrict distribution to only those retail outlets which agreed to keep this information and report it to the manufacturer, but such restrictions would increase the cost of distribution which would be passed on to consumers and would eliminate many of the largest retail distributors from consideration, thereby limiting the availability of these life-saving devices. A tension is thus present between the desire to make AEDs readily available to the general public and the desire to track the locations of the AEDs for possible future contact for service or repair.

In accordance with the principles of the present invention OTC AEDs are distributed through retail outlets with no requirement imposed by the manufacturer on the retailer to record and send purchaser/owner information to the AED manufacturer at the time of sale. The OTC AED includes a postcard addressed to the manufacturer which the purchaser is asked to complete and send to the manufacturer. In the event of the need to contact owners of the OTC AEDs, the retailer responds to a request to provide contact information it may have of OTC AED purchasers. This method of distribution assures widespread availability of OTC AEDs at reasonable distribution costs and requirements while providing a means for contacting many OTC AED owners in the event such need should arise.

In the drawings:

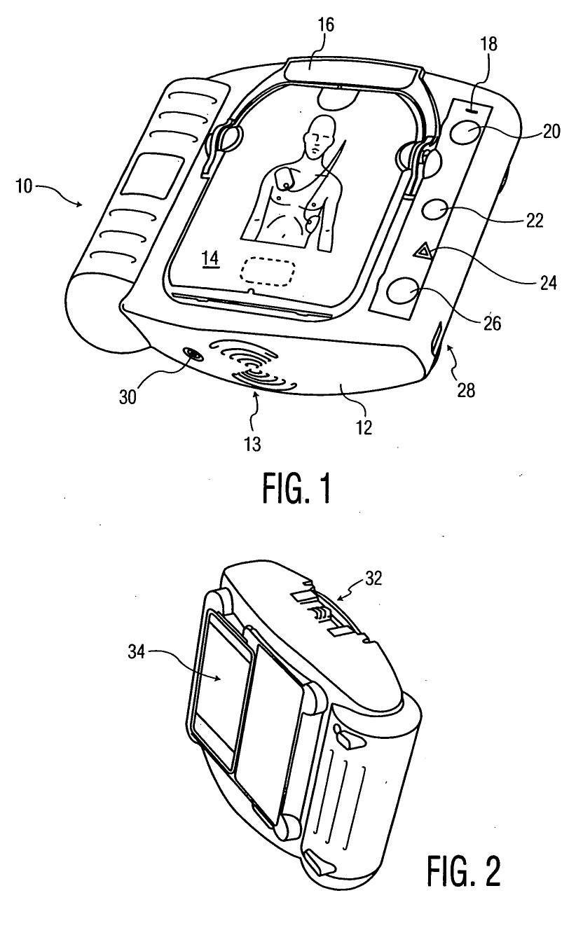

FIG. 1 illustrates a top perspective view of an OTC automatic external defibrillator.

FIG. 2 illustrates a bottom perspective view of the OTC automatic external defibrillator of FIG. 1.

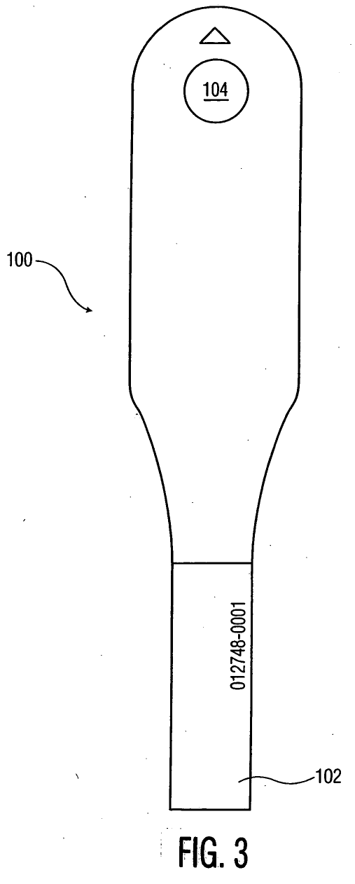

FIG. 3 illustrates a pull tab which connects the battery to an OTC AED and initiates the setup procedure.

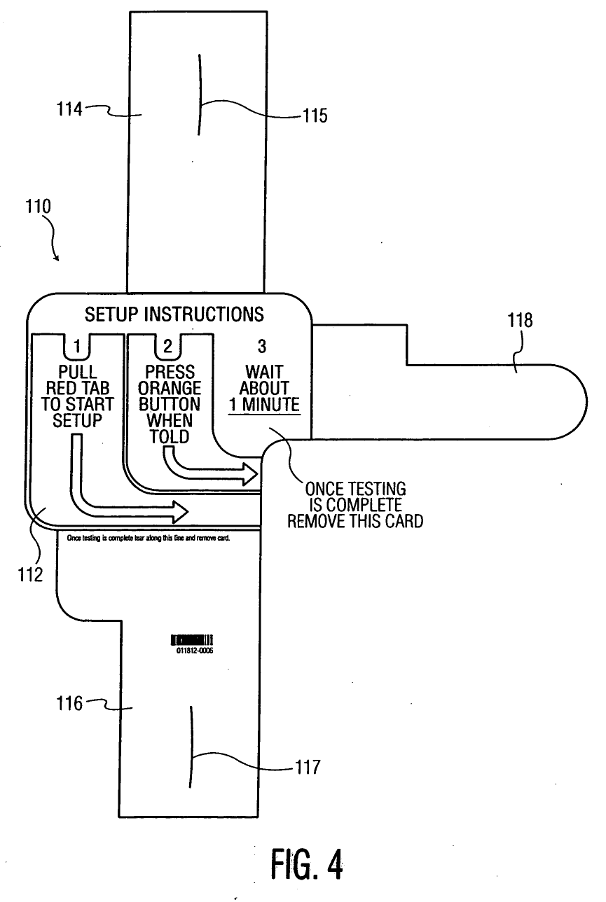

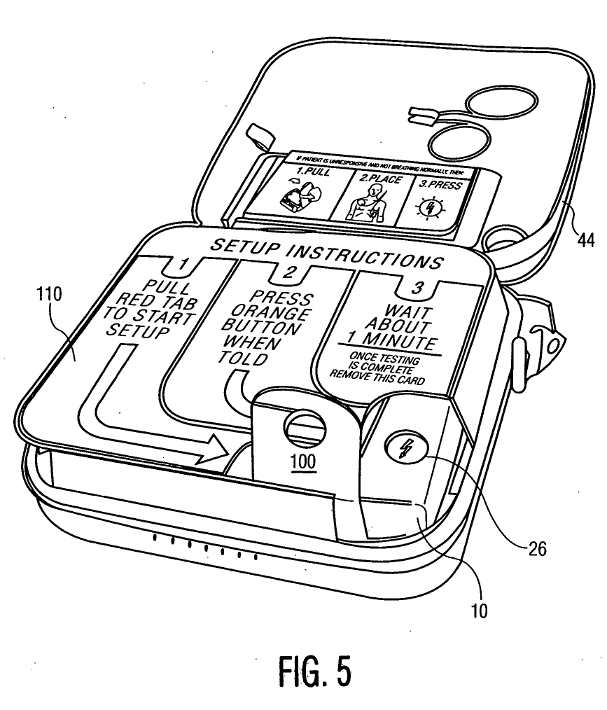

FIGS. 4 and 5 illustrate a shipping cover which facilitates the setup procedure.

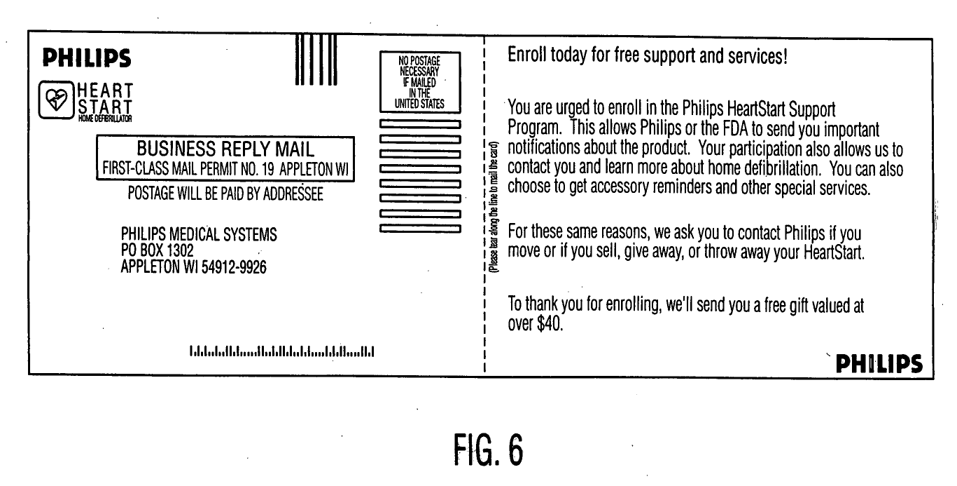

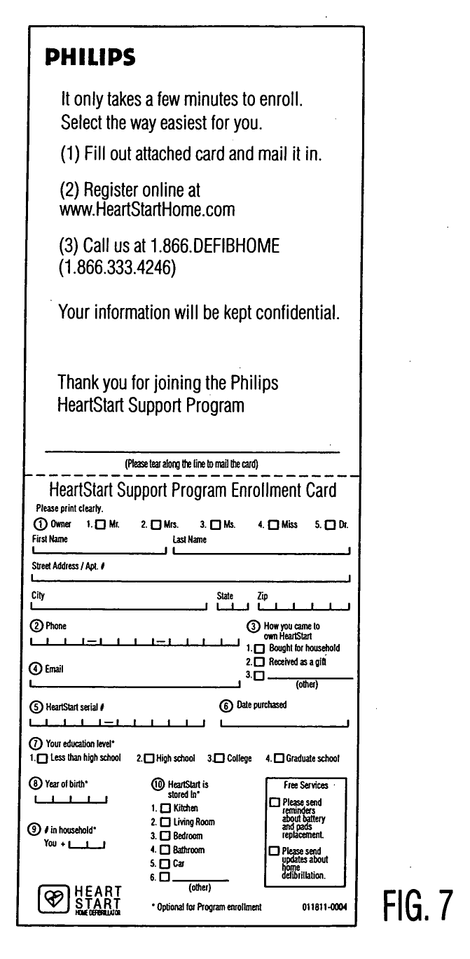

FIGS. 6 and 7 illustrate the front and back of an OTC AED support program enrollment card.

Referring first to FIG. 1, an OTC AED 10 is shown in a top perspective view. The OTC AED 10 is housed in a rugged polymeric case 12 which protects the electronic circuitry inside the case and also protects the layperson user from shocks. In this example the case is colored a distinctive color which readily identifies the OTC AED to the layperson user, such as red, yellow, orange, green, blue, black, or combinations thereof. Other suitable distinctive colors are light green, silver gray, and various shades of white or off-white. Combinations of the aforementioned colors also provide distinctive colorings to the layperson user such as yellow/black, yellow/blue, yellow/white gold/black, blue/silver, 5 yellow/blue/black, and blue/white/black. Other distinctive colors include the yellows, oranges and reds often used for traffic signs and signals. It is important in the home environment that the OTC AED be marked by a prominent color or colors so as to be immediately recognized by a potential rescuer in the event of a home cardiac emergency. Unlike airports and public facilities where AEDs are generally mounted in distinctive locations such as on walls in high traffic areas and with signage to mark and indicate their locations, an OTC AED may be placed anywhere in the home. Since a home OTC AED may go an extended period of time without use, it may be stored in a location lacking prominence such as in a closet or drawer. Accordingly it is very important for the OTC AED to bear a distinctive color as this may be the primary means by which a rescuer can quickly locate the OTC AED in the home during an emergency. The OTC AED may be stored when not in use in a carrying case which may be a distinctive color such as red, black, navy blue, or blue/yellow color.

Attached to the case 12 by electrical leads are a pair of electrode pads. In the example of FIG. 1 the electrode pads are in a sealed airtight cartridge 14 located in a recess on the top side of the OTC AED 10. The electrode pads are accessed for use by pulling up on a handle 16 which allows removal of a plastic cover over the electrode pads. A small ready light 18 informs the user of the readiness of the OTC AED. In this example the ready light blinks after the OTC AED has been properly set up and is ready for use. The ready light is on constantly when the OTC AED is in use, and the ready light is off when the OTC AED needs attention.

Below the ready light is an on/off button 20. The on/off button is pressed to turn on the OTC AED for use. To turn off the OTC AED a user holds the on/off button down for one second or more. An information button 22 flashes when information is available for the user. The user depresses the information button to access the available information. A caution light 24 blinks when the OTC AED is acquiring heartbeat information from the patient and lights continuously when a shock is advised, alerting the rescuer and others that no one should be touching the patient during these times. Interaction with the patient while the heart signal is being acquired can introduce unwanted artifacts into the detected ECG signal. A shock button 26 is depressed to deliver a shock after the OTC AED informs the rescuer that a shock is advised. An infrared port 28 on the side of the OTC AED is used to transfer data between the OTC AED and a computer. This data port find used after a patient has been rescued and a physician desires to have the OTC AED event data downloaded to his or her computer for detailed analysis.

A speaker 13 provides voice instructions to a rescuer to guide the rescuer through the use of the OTC AED to treat a patient. A beeper 30 is provided which “chirps” when the OTC AED needs attention such as electrode pad replacement or a new battery.

FIG. 2 illustrates another view of the OTC AED 10 in which a cartridge latch 32 is seen on the upper end of the OTC AED. When this latch is pushed to the right the electrode pad cartridge is released from its recess in the OTC AED case 12. The cartridge latch 32 is used when an electrode pad cartridge is to be replaced or exchanged for a training pad set for training on the OTC AED. On the back of the OTC AED case is a battery compartment which houses a battery 34 that powers the OTC AED. In this example the battery 34 is a disposable battery. When the battery 34 becomes discharged, generally after about four years in the readiness state, it is replaced with a fresh battery.

In this example the OTC AED contains self-test circuitry which automatically monitors the state of various parts of the OTC AED on a regular basis. Self-test circuitry is very important for an OTC AED because it cannot be expected that owners of the OTC AED will adhere to any formal maintenance schedule for the OTC AED. One component that is self-tested in this example is the battery and another is the electrode pad set. The electrode pads include an adhesive gel which adheres the electrodes to the patient and provides good electrical conductivity with the patient. This adhesive gel is hydrophilic and over time can become subject to desiccation which reduces the effectiveness of the pads. In the hospital setting or the medical emergency responder setting electrode pads are generally used in a relatively short time-frame and desiccation is often not a problem. In addition, these medical professionals are generally more cognizant of the need for attention to expiration dates and other maintenance to their medical equipment. Electrode pads for the prescription defibrillators used by these medical professionals are often not connected to the defibrillator until the defibrillator is to be used and thus cannot be tested by the AED prior to use. Organizations such as airports and office buildings which have deployed defibrillators generally do so under the direction of a medical officer who oversees a maintenance program for the defibrillators. Prescription defibrillators are dispensed under the watchful eye of the prescribing physician who will be mindful of needed periodic maintenance such as electrode pad replacement. In the home environment where the OTC AED is not part of a systematic maintenance program it is to be expected that an OTC AED may sit in readiness for the full two-year anticipated lifetime of a typical electrode pad set without being inspected or used.

Accordingly, in one example of the present invention the electrode pads are normally electrically connected to the OTC electronic unit 10 and its self-test circuitry while the OTC AED is in the readiness state. With an electrode pad cartridge this can be done by embedding conductors in the wall of the cartridge. The electrode pad leads inside the cartridge are connected to these conductors, which enables electrical connectivity to the exterior of an air-tight sealed cartridge. The cartridge conductors engage mating conductors in the recess of the OTC AED case, thereby putting the electrode pads into electrical communication with the OTC AED self-test circuitry. This permits the electrode pads to be automatically tested by the OTC AED on a periodic basis by measuring the impedance through the circuit which includes electrical leads to each electrode pad, the conductor of each electrode, and the conductive gel on each electrode conductor. If the self-testing determines that the electrode pads have dried out or suffered some other detected deterioration as by an impedance measurement which is outside an expected impedance range, the user is alerted to replace the pads by the chirping of the beeper 30 and the absence of the ready light 18. Further details of electrode self-testing may be found in U.S. Pat. No. 6,694,193, the contents of which are incorporated herein by reference.

In accordance with the principles of the present invention OTC AEDs are sold by retailers and distributors with no requirement imposed by the manufacturer to record and send purchaser/owner contact information to the manufacturer. This distribution method enables mass distribution retailers to sell OTC AEDs in the same way they sell other OTC medical devices such as first aid kits and adhesive bandages. Thus, this distribution method is compatible with existing OTC device distribution and is viewed favorably by large retailers. The distribution method also enables such retailers to stock and process an inventory of OTC AEDs in the same way as their other merchandise. Thus, distribution costs are kept low.

The manufacturer will keep its won database of the individuals/entities to whom it ships AEDs. Generally this database will include the serial numbers of all AEDs shipped together with the identity of the retailer or distributor who whom each AED was shipped. If a need arises to contact the owner of a particular AED or lot of AEDs, this database enables the manufacturer to identify the retailer or distributor who needs to be contacted for owner information.

In accordance with a further aspect of the present invention, retailers and distributors of the OTC AEDs agree to provide information they may have on hand which contains OTC AED purchaser or user contact information if called upon to do so in certain situations. Such situations may include, for instance, a discovery by the manufacturer or FDA that important information about purchased OTC AEDs needs to be conveyed to OTC AED owners. This information may comprise instructions to replace a component of the OTC AED such as a battery or electrode pads or to return the OTC AED to the manufacturer for repair or replacement. In such situations the retailers and distributors will provide contact information they may have to the requesting entity to aid in the contact of OTC AED owners. Thus, this information reporting method strikes a balance between the imposition of data collection requirements on retailers and distributors and the provision of available contact information when it is needed.

When defibrillators of the present invention are shipped to retailers or purchasers the units are shipped without the battery being installed. This prevents the possibility of the AED beeping or alarming during shipment or storage when it may be in a container with a common carrier, on an airplane or truck, or in an airport or other transit facility. A container in an airport which suddenly started to emit an audible alert could be very alarming to airport personnel. Thus, AEDs are conventionally not shipped with the batteries installed because of the possibility that a self-test performed during shipment could detect an error condition, causing the defibrillator to issue its audible alerts for maintenance during shipment, a situation to be avoided for obvious reasons such as airline safety. There is also the possibility of inadvertent activation and the resultant hazard if the high voltage circuitry begins to charge the defibrillator capacitor to its usual level of hundreds or thousands of volts. After the defibrillator is received by the owner, the first action of the medical professional is to install the battery in the defibrillator, at which point the defibrillator usually performs a self-test known as a “battery insertion test.” This process begins the setup of the defibrillator, which may require periodic intervention by the medical professional before setup is complete.

As mentioned above, it is important that an OTC AED be promptly set up when the layperson owner takes it home. Furthermore, it is desirable to make setup as simple as possible for the nonmedical layperson. In accordance with the principles of the present invention setup of the OTC AED is simplified by providing the OTC AED with its battery already installed in its battery compartment, alleviating the layperson of this task. However, to prevent inadvertent alarming or charging of the high voltage circuitry and capacitor during shipment, the battery circuit is broken by a nonconductive pull tab 100 during shipment as illustrated in FIG. 3. The distal end 102 of the pull tab 100 is disposed in the battery circuit such as between one battery terminal and its contact on the OTC AED. In a constructed example the battery has four terminals which engage four contacts on the OTC AED, and the distal end 102 is disposed between all four terminals and contacts, completely isolating the battery from the high voltage circuitry of the OTC AED. The pull tab 100 may be made of a sheet of nonconductive material such as paper or cardboard. In a constructed product the pull tab 100 is made of a thin polymeric sheet which is tough enough not to tear when a finger is inserted in the hole 104 in the proximal end of the pull tab and the pull tab is pulled from between the battery terminals and OTC AED contacts. The thin sheet enables the battery to be latched in place in the battery compartment while the pull tab is in place during shipment. The polymeric material also gives the pull tab a resilient property. During shipment in a constructed product the pull tab is folded over the top of the OTC AED when the OTC AED is in the carrying case, and the case is closed. When the case is opened for the first time the resilient pull tab pops up, immediately informing the layperson what is to be done first. The pull tab may be labeled with instructions at its proximal end such as “pull” or “remove first”, or it may be labeled with a graphic is such as an arrow pointing up (shown above hole 104), or it may be left unlabeled, with the pop-up characteristic speaking for itself.

It will be appreciated that it is not necessary for the pull tab to pop up when the OTC AED is initially accessed as described above. In another example the pull tab may be prominently positioned so that it is one of the first items seen by the new owner when opening the OTC AED package. It is sufficient in most situations if the owner recognizes the pull tab and understands that it is to be removed.

While the installed battery is a benefit because it alleviates the layperson purchaser of this task, it is also an advantage because the OTC AED packaging does not have to accommodate a separate battery pack and thus can be made smaller. In a constructed product the OTC AED with battery installed and in its carrying case 44 measured 3½″ by 8″ by 9″, a total of 252 in³, and was packed in packaging measuring 6.5″ by 8.375″ by 10.5”, a total of 572 in³. The OTC AED and case thus occupy 44% of the packaging volume.

In accordance with a further aspect of the present invention, the top of the OTC AED is covered with a sheet 110 that obscures from the user certain ones of the controls of the OTC AED, seen in FIG. 1, except for those that are to be used to set up the OTC AED. An example of a sheet 110 is shown in FIG. 4, comprising the top area 112 which covers the top of the OTC AED and contains three instructions: pull the red tab 100 to start the automated setup process; press the orange button indicated by the second arrow when prompted by an audible instruction; and wait until an audible prompt announces that the setup is complete. Two tabs 114 and 116 extend from the top area 112 and fold under the OTC AED, where they are engaged through slits 115 and 117 by a third tab 118, retaining the cover in place around the OTC AED. In a constructed example this sheet comprises removable cardboard packing that covers all but the shock button 26 on the top of the OTC AED 10 as shown in FIG. 5.

When the new purchaser/owner opens the carrying case 44 for the first time, the pull tab 100 pops up and the purchaser/owner responds by pulling the tab, connecting the battery terminals to the contacts of the OTC AED. The OTC AED will then immediately commence its battery insertion test, and the audible prompts may announce to the purchaser/owner that testing is underway. During or at the conclusion of the battery insertion test, the purchaser/owner is asked to respond by pressing the shock button 26. At this point no other controls are visible to the purchaser/owner by reason of the cover sheet 110 covering the top of the OTC AED controls except for the shock button. The cover sheet also inhibits the purchaser/owner from pressing any other buttons on the OTC AED while the battery insertion test is in progress. In the illustrated example the cover sheet 110 also obscures the pull handle for the pads cartridge as it is not necessary for the purchaser/owner to pull this handle during setup. At the conclusion of the battery insertion test, no additional user intervention is needed. The purchaser/owner can dispose of the pull tab 100 and the cover sheet 110 and the OTC AED is set up and ready for use in a cardiac emergency.

Owners of OTC AEDs may have different individual requirements for storing and training for use of the OTC AED. In accordance with a further aspect of the present invention an OTC AED is sold in multiple accessory configurations. In the most basic configuration the OTC AED is sold in packaging containing only the OTC AED (and carrying case if it has one) and the literature kit for the unit. A typical literature kit includes instructions for setup and use, warranty information, support program reply card as described below, training video, and possibly other information. In the “training” configuration the packaging contains the OTC AED (and case, if appropriate), the literature kit, and a package of training pads. The training pads are used with the OTC AED when the user wants to train himself or others in the use of the OTC AED. In the “emergency healthcare” configuration the packaging contains the items of the training configuration and a first aid kit which the owner may also use for home medical emergencies. In the “wall mount” configuration the packaging contains all of the items of the emergency healthcare configuration and a wall mount for mounting the OTC AED on a wall. It will be appreciated that in a given situation different mixes of these items will be included and other packaging configurations can be arranged. For example, a configuration of the OTC AED, carrying case, literature kit, training pads and wall mount may be desirable for certain users who already have a first aid kit.

As previously mentioned it is to be anticipated that the consumer owner of an OTC AED will be unmindful of any maintenance needs of the OTC AED while it is in its standby state. In accordance with a further aspect of the present invention, a support program for an OTC AED is provided by multiple communications with the owner of the OTC AED. To facilitate these communications a mail-in support program card is included in the packaging of the OTC AED, an example of which is shown in FIGS. 6 and 7. The support program card elicits the owner's contact information such as mailing address and telephone number and has a space for the serial number of the OTC AED. The card may also request that the manufacturer be notified if ownership of the OTC AED is transferred to someone else or if the OTC AED is no longer in service. It may also provide a space where the owner can state the kind of support desired, such as reminders when the battery or pads need replacing or updates on home defibrillation. In the illustrated embodiment the support program card comes with detachable instructions and offers an incentive if the card is returned as requested.

The mail-in postcard also provides an additional source of owner contact information for the manufacturer. While owners are not required to submit the postcards, many will do so voluntarily, particularly if given an incentive to do so. Thus, if a need arises to contact OTC AED owners the manufacturer will have two sources of this information: the information obtained from the returned owner postcards as augmented by any information provided in response to a request to the retailers and distributors. While this approach cannot guarantee that every OTC AED owner can be contacted, it does present an opportunity to reach a large number of owners. Advertising and mass media can be used to reach others.

It will be appreciated that as an alternative to a mail-in postcard, OTC AED owners can be given the option to submit this information via the Internet such as by registering at the manufacturer's Website. As another alternative, owners can be given a telephone number, preferably a toll-free number, to enable owners to submit the registration information over the telephone if they so desire.

When the new owner enrolls in the support program and provides the necessary contact information, periodic contacts with the owner may then be conducted. For example, a first such communication can be a letter mailed to the enrolled owner of the OTC AED after approximately the first year of ownership. Such a letter may remind the owner to check the battery and pads of the OTC AED to see if they need replacing, and to set up the OTC AED if that has not already been done. The letter may also offer training opportunities to the owner such as reviewing a training video. The letter may also solicit information such as whether the OTC AED was used in an emergency during the past year and whether its ownership or possession have been transferred to another person. A second such communication may occur after two years of ownership, which is approximately the time that pads need replacing. In addition to the foregoing, the letter may remind the owner that the pads of the OTC AED need replacing and may include contact information and an incentive to do so. A similar communication may be sent at the later date when the battery is scheduled for replacement. Such a support program can help keep a potential home rescuer trained to use the OTC AED, can help keep the OTC AED properly maintained, and provides a means to follow ownership of the OTC AED through successive owners so that such services can continue with whomever owns the OTC AED. As previously mentioned, the contact information also provides a means for the manufacturer to contact the owner if upgrades or improvements or critical information concerning the OTC AED become available in the future.

What is claimed is:

1. A method of distributing over-the-counter automatic external defibrillators comprising:
selling an over-the-counter automatic external defibrillator to a purchaser without a prescription and without requiring owner contact information from the purchaser at the time of purchase;
including with the over-the-counter automatic external defibrillator instructions for sending owner contact information to a repository of such information; and
arranging for the seller of the over-the-counter automatic external defibrillator to provide purchaser contact information the seller may have in the event of a need to provide important information to the purchaser/owner.

2. The method of claim 1, wherein selling further comprises selling an over-the-counter automatic external defibrillator by a retailer or distributor.

3. The method of claim 2, wherein selling further comprises selling an over-the-counter automatic external defibrillator by a retailer or distributor who stocks over-the-counter automatic external defibrillators.

4. The method of claim 1, wherein including further comprises including in the packaging of the over-the-counter automatic external defibrillator a postcard which is to be completed with owner contact information.

5. The method of claim 1, wherein including further comprises including in the packaging of the over-the-counter automatic external defibrillator instructions for sending owner contact information over the Internet and/or the telephone.

6. The method of claim 1, wherein including further comprises including in the packaging of the over-the-counter automatic external defibrillator an incentive for the purchaser to send owner contact information.

7. The method of claim 1, wherein arranging further comprises contracting with a retailer or distributor to sell over-the-counter automatic external defibrillators.

8. The method of claim 1, wherein arranging further comprises arranging for the seller of the over-the-counter automatic external defibrillator to provide purchaser contact information the seller may have in the event of the need to provide safety-related information to the owners of over-the-counter automatic external defibrillators.

9. The method of claim 8, wherein arranging further comprises arranging for the seller of the over-the-counter automatic external defibrillator to provide purchaser contact information the seller may have in the event of a product recall by the FDA or the defibrillator manufacturer.

10. The method of claim 8, wherein arranging further comprises arranging for the seller of the over-the-counter automatic external defibrillator to provide purchaser contact information the seller may have in the event of the discovery of the need for servicing the over-the-counter automatic external defibrillator with new hardware or software.

11. The method of claim 1, wherein arranging further comprises arranging for the seller of the over-the-counter automatic external defibrillator to provide purchaser contact information it may have without requiring the seller to maintain any specific information.

12. The method of claim 1, wherein arranging further comprises arranging for the seller of the over-the-counter automatic external defibrillator to provide purchaser contact information it obtains in the normal course of its business.

13. The method of claim 1, wherein selling further comprises selling an over-the-counter automatic external defibrillator in a store or over the Internet or through a catalog or over the telephone.

14. A method of distributing over-the-counter automatic external defibrillators comprising:
selling an over-the-counter automatic external defibrillator through a retailer or distributor to a purchaser without a prescription and without requiring owner contact information from the purchaser at the time of purchase;
including with the over-the-counter automatic external defibrillator a mail-in card by which a purchaser/owner can submit owner contact information to the defibrillator manufacturer, retailer, or distributor; and
contracting with the seller of the over-the-counter automatic external defibrillator to provide purchaser contact information the seller may have in the event of a need to contact the owner of the over-the-counter automatic external defibrillator.

15. The method of claim 14, wherein selling further comprises selling an over-the-counter automatic external defibrillator through a retailer or distributor to a purchaser without requiring the retailer or distributor to provide owner contact information to the manufacturer of the over-the-counter automatic external defibrillator shortly after the time of purchase.

16. The method of claim 14, wherein including further comprises pre-addressing a mail-in postcard to the address of the defibrillator manufacturer.

17. The method of claim 14, wherein contracting further comprises contracting with the seller of the over-the-counter automatic external defibrillator to provide purchaser contact information it may have without requiring the seller to maintain any specific information.

18. The method of claim 14, wherein contracting further comprises contracting with the seller of the over-the-counter automatic external defibrillator to provide purchaser contact information the seller may have in the event of a product recall or required product upgrade.
